(19) United States
(12) Patent Application Publication
(10) Pub. No.: US 2010/0219089 A1
(43) Pub. Date: Sep. 2, 2010

(54) INFLATABLE CASE TO TRANSPORT A SURFBOARD AND A METHOD FOR MAKING THE SAME

(75) Inventor: Perry Samios, Santa Cruz, CA (US)

Correspondence Address: K&L Gates LLP;IP Docketing, 630 HANSEN WAY, PALO ALTO, CA, 94304, US

(73) Assignee: Soma AirBag Designs

(21) Appl. No.: 12/396,232

(22) Filed: Mar. 2, 2009

(51) Int. Cl. B65D 85/30; B65D 81/02; B29C 65/02

(52) U.S. Cl. 206/315.1; 206/522; 206/586; 156/275.1

(57) ABSTRACT

Inventive case capable of transporting a surfboard is described. The surfboard includes a top cushion designed to conform to a top surface of a surfboard, a bottom cushion designed to conform to a bottom surface of the surfboard such that each of the top and the bottom cushions include a plurality of compartments which have varying cross-sectional dimensions along a length of the compartments.

### FIELD OF THE INVENTION

The present invention relates to a case designed to transport a surfboard. More particularly,.the present invention relates to a surfboard case including cushions with varying thickness along their length and a method for making the same.

### BACKGROUND OF THE INVENTION

Surfboards are frequently transported inside a case from a surfer's home or location of storage to a surfing site. Surfing sites can be local, but may also include distant or international destinations. As a result, current designs of cases attempt to protect the encased surfboard from damage during transit. Specifically, current design of cases attempt to protect the surfboard from being impacted by an external force (e.g., from movement of adjacent bags, applied by the loading or unloading personnel or exerted by transporting equipment).

Commonly available designs contemplate cases made from synthetic rubber foam sheet material of uniform thickness for covering the surfboard. Unfortunately, they do not provide sufficient protection to the top and bottom surfaces of a surfboard during transit. Moreover, when not in use, these cases do not collapse or fold for easy storage.

To this end, U.S. Pat. No. 7,017,747 entitled “Protective Inflatable Surfboard Covering Device” issued to Kiger et al. offers a surfboard case design that is inflatable. Specifically, this design provides an inflatable top and an inflatable bottom cushion of uniform thickness to cover the top and bottom surfaces of a surfboard. Furthermore, this design also includes a side rail cushion having an inwardly “C-shape” that is designed to partially circumscribe the side rails.

In FIG. 1, a typical surfboard 10 having a front portion 12, a middle portion 16 and a back portion 14 is shown. Side rails 8 extend from front portion 12 to back portion 14 on both sides of surfboard 10. In U.S. Pat. No. 7,017,747, “C-shaped” side rail cushion in its inflated position will assume a concave curvature to complement or conform and embrace the generally convex structure of side rail 8.

Unfortunately, however, the prior art inflatable case design does not adequately protect the surfboard inside. With the top and bottom cushions of uniform thickness, the design does not properly protect the pronounced rise in the curvature at front portion 12 and slight rise in back portion 14 of the surfboard. In other words, in the current design an external force impacting either a top or a bottom surface of the case does not have much to travel before it strikes either the rising front or back portions of the encased surfboard. Consequently, the top and bottom surfaces of the surfboard are not adequately protected by the prior art inflatable design.

What is therefore needed is a new surfboard design that effectively protects the rising curvature at the front and back portions of the surfboard and also the top and bottom surfaces of the surfboard from an impacting external force.

### SUMMARY OF THE INVENTION

To achieve the foregoing, the present invention provides in one aspect a case capable of transporting a surfboard. The surfboard includes: (1) a top cushion designed to conform to a top surface of a surfboard; (2) a bottom cushion designed to conform to a bottom surface of the surfboard; and (3) wherein each of the top and the bottom cushions include a plurality of compartments which have varying cross-sectional dimensions along a length of the compartments. The top cushion, the bottom cushion and compartments can be made from foam like materials.

In an alternative embodiment of the present invention, the top and bottom cushions and said plurality of compartments are inflatable and the compartments have defined therein an aperture which allows air to travel from one compartment to another compartment. The case may further include a side rail cushion that is disposed between the top cushion and the bottom cushion and is designed to be adjacent to a side rail of the surfboard when the surfboard is encased inside the case.

In preferred embodiments of the present invention, at a distance which equals between about 0 and about ⅓ of a length of the case and the distance measured from the front end of the case, a cross-sectional area of the compartment of the top cushion is between about 4 square inches and about 30 square inches. At a distance which equals between more than ⅓ and about ⅔ of a length of the case and the distance being measured from a front end of the case, a thickness of the inflatable compartment of the top cushion in an inflated state may be between about 6 square inches and about 30 square inches. At a distance which equals between about 0 and about ⅓ of a length of the case and the distance measured from a back end of the case, a thickness of the inflatable compartment of the top cushion in an inflated state may be between about 4 inches and about 24 inches. At a distance which equals between about 0 and about ⅓ of a length of the case and the distance being measured from a front end of the case, a thickness of the inflatable compartment of the bottom cushion in an inflated state may be between about 6 square inches and about 30 square inches. At a distance which equals between about ⅓ and about ⅔ of a length of the case and the distance measured from a front end of the case, a thickness of the inflatable compartment of the bottom cushion in an inflated state may be between about 4 square inches and about 24 square inches. At a distance which equals between about 0 and about ⅓ of a length of the case and the distance measured from a back end of said case, a thickness of the inflatable compartment of the bottom cushion in an inflated state may be between about 4 square inches and about 30 square inches.

In another aspect, the present invention provides a case capable of transporting a surfboard. The surfboard includes: (1) a top inflatable cushion designed to conform to a top surface of a surfboard in an inflated state of the top cushion; (2) a bottom inflatable cushion designed to conform to a bottom surface of the surfboard in an inflated state of the bottom cushion; and (3) wherein in an inflated state, each of the top and the bottom cushions vary in thickness along their length to protect the top surface and bottom of surfboard from being impacted from an external force when the surfboard is secured inside the case.

In alternative embodiments of the present invention, the case further includes a side rail cushion that is capable of being disposed between the top and the bottom cushions. Although the inventive case need not be inflatable, in one preferred embodiment of the invention, the case is made from inflatable components. For example, the top and the bottom cushion may be inflatable such that in an inflated state the top cushion conforms to the top surface of the surfboard and the bottom cushion conforms to the bottom surface of the surfboard and the case further includes a first valve designed to inflate the top cushion, a second valve designed to inflate the bottom cushion and a third valve designed to inflate the side rail cushion.

At a distance which equals between about 0 and about ⅓ of a length of the case and the distance measured from the front end of the case, a thickness of the inflatable compartment of the top cushion in an inflated state may be between about 2 inches and about 4 inches. At a distance which equals between more than ⅓ and about ⅔ of a length of the case and the distance measured from a front end of the case, a thickness of the inflatable compartment of the top cushion in an inflated state may be between about 2.5 inches and about 4.75 inches. At a distance which equals between about 0 and about ⅓ of a length of the case and the distance measured from a back end of the case, a thickness of the inflatable compartment of the top cushion in an inflated state may be between about 2 inches and about 4.75 inches. At a distance which equals between about 0 and about ⅓ of a length of the case and the distance measured from a front end of the case, a thickness of the inflatable compartment of the bottom cushion in an inflated state may be between about 2 inches and about 4.75 inches. At a distance which equals between about ⅓ and about ⅔ of a length of the case and the distance measured from a front end of the case, a thickness of the inflatable compartment of the bottom cushion in an inflated state may be between about 2.5 inches and about 3.5 inches. At a distance which equals between about 0 and about ⅓ of a length of the case and the distance measured from a back end of the case, a thickness of the inflatable compartment of the bottom cushion in an inflated state may be between about 2 inches and about 4.75 inches.

In yet another aspect, the present invention provides a method for manufacturing a case. The method of manufacturing includes: (1) fabricating a plurality of longitudinal inflatable compartments having varying cross-sectional areas along their lengths; and (2) adhering some of the longitudinal compartments to form a top cushion and adhering others of the longitudinal compartments to form a bottom cushion.

The method may further include: (1) fabricating a side rail cushion; and (2) joining a portion of the side rail cushion to the top cushion and another portion of the side rail cushion to the bottom cushion for forming an envelope which is capable of receiving a surfboard.

In one embodiment of the present invention, the step of fabricating is carried out by either extruding or casting. The step of adhering is preferably carried out by heat welding. In certain embodiments of the inventive process, the step of fabricating the plurality of longitudinal compartments includes forming inflatable compartment which include an aperture in each of the plurality of longitudinal compartments. The step of fabricating may also include a first valve for providing air inside the top cushion, a second valve for providing air inside the bottom cushion and a third valve for providing air inside the side rail cushion.

### BRIEF DESCRIPTION OF THE FIGURES

FIG. 1 is a side view of a surfboard.

FIG. 2 is a side-sectional view of a surfboard inside a surfboard case, according to one embodiment of the present invention.

FIG. 3 is side-sectional view of a surfboard case as shown in FIG. 2, but without a surfboard inside the case.

FIG. 4A shows a top view of a top cushion which is one component of the surfboard shown in FIG. 3.

FIG. 4B shows a top view of a bottom cushion which is another component of the surfboard shown in FIG. 3.

FIG. 5 shows a top perspective view of a top cushion attached to side rails according to one embodiment of the present invention.

FIG. 6A shows an exemplar inflatable compartment in top cushion as shown in FIG. 4A.

FIG. 6B shows an exemplar inflatable compartment in bottom cushion as shown in FIG. 4B.

### DETAILED DESCRIPTION OF THE INVENTION

The present invention provides inventive designs for a surfboard case and methods for making the same. Prior art surfboard case designs provide cushions of uniform thickness. In sharp contrast, the present invention offers surfboard case designs that provide cushions of non-uniform thickness. In the present invention, the surfboard case can be made from foam like material or from an inflatable material. Given that an inflatable design is easy to transport, it represents a preferred embodiment of the present invention.

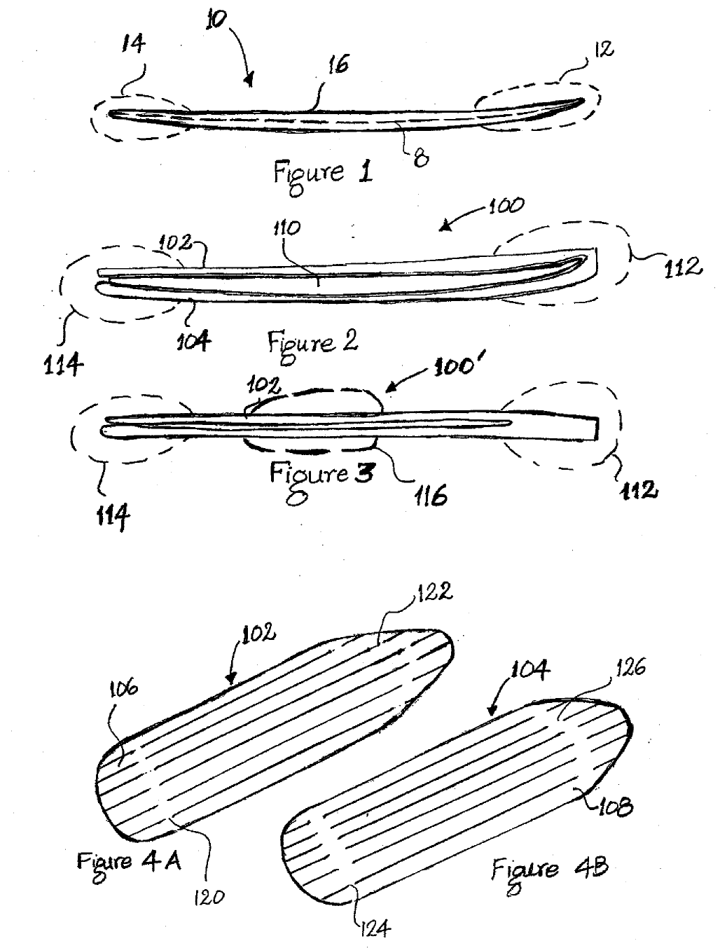

FIG. 2 shows a case 100, in an inflated state, according to one embodiment of the present invention. Case 100 encases a surfboard 110, which is similar to surfboard 10 of FIG. 1. As shown in FIG. 2, case 100 includes a top cushion 102 and a bottom cushion 104. Top cushion 102 is designed to conform to a top surface of surfboard 110 and bottom cushion 104 is designed to conform to a bottom surface of surfboard 110. In an inflated state, each of top cushion 102 and bottom cushion 104 vary in thickness along their length. Those skilled in the art will recognize that a case made from foam like material will have cushions which are also made from foam like material and similarly vary in thickness along the length of the cushions to conform to the different surfaces of the surfboard.

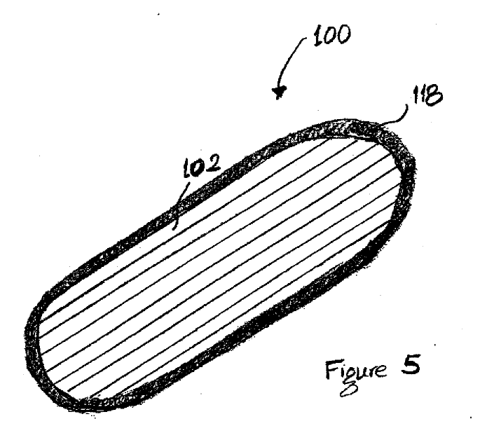

FIG. 3 shows a case 100′ in an inflated state and which is similar to case 100 of FIG. 2, except it does not include surfboard 110. As shown in FIG. 3, the length of each of top cushion 102 and bottom cushion 104 extends from a front tip located at a front portion 112 to a back end located at a back portion 114. At back portion 114, which approximately equals a distance between about 0 and about ⅓ the length of the case and is measured from the back end of case 100′, top cushion 102 has a thickness that ranges from between about 2 inches to about 4 inches. At a middle portion 116, which approximately equals a distance between more than ⅓ and about ⅔ the length of the case and is measured from the back end of case, top cushion 102 has a thickness that ranges from between about 2.5 inches to about 4.75 inches. At a front portion 112, which approximately equals a distance between about 0 and about ⅓ the length of the case and is measured from the front tip of case 100′, top cushion 102 has a thickness that ranges from between about 2 inches to about 4.75 inches.

Similarly, at back portion 114, bottom cushion 102 has a thickness that ranges from between about 2 inches to about 4.75 inches. At a middle portion 116, bottom top cushion 102 has a thickness of between about 2.5 inches to about 3.5 inches. At a front portion 112, bottom cushion 102 has a thickness that ranges from between about 2.5 inches to about 4.5 inches.

FIG. 4A shows that top cushion 102 includes a plurality of longitudinally extended inflatable compartments 106, which are communicatively coupled to each other through apertures 120 and 122. Similarly, FIG. 4B shows that bottom cushion 104 includes a plurality of longitudinally extended inflatable compartments 108, which are communicatively coupled to each other through apertures 124 and 126. Each of top cushion 102 and bottom cushion come fitted with at least one valve (not shown to simplify illustration) which allows inflation of compartments with air.

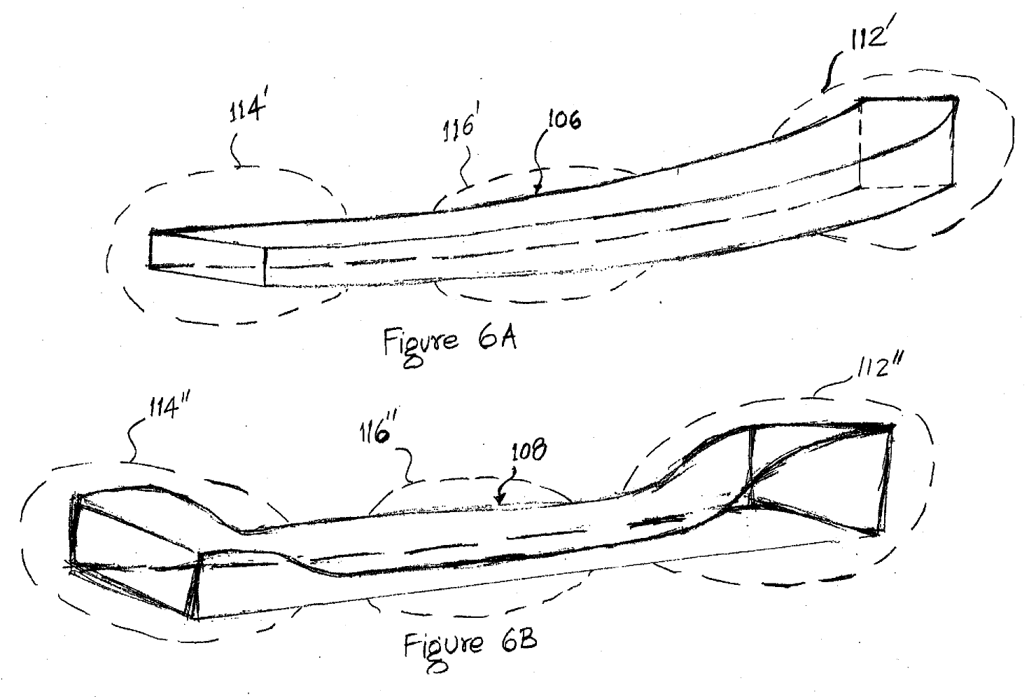

FIG. 6A shows a lengthwise cross-sectional view of one inflatable compartment which is used to manufacture top cushion 102. According to this figure, a length of an inflatable compartment 106 extends from a back end located at a back portion 114′ through a middle portion 116′ to a front tip located at a front portion 112′, At back portion 114′, which approximately equals a distance between about 0 (i.e. back end) and about ⅓ the length of compartment 106 and is measured from the back end of compartment 106, compartment 106 has a cross-sectional area that ranges from between about 4 square inches to about 24 square inches. At a middle portion 116′, which approximately equals a distance between more than ⅓ and about ⅔ the length of the compartment 106 and is measured from the back end of compartment 106, compartment 106 has a cross-sectional area that ranges between about 6 square inches to about 30 square inches. At a front portion 112′, which approximately equals a distance between about 0 and about ⅓ the length of compartment and is measured from the front tip of compartment 106, compartment 106 has a cross-sectional area that ranges from between about 4 square inches to about 30 square inches.

Similarly, at back portion 114″, bottom cushion 108 has a cross-sectional area that ranges from between about 4 square inches to about 30 square inches. At a middle portion 116″, bottom cushion 108 has a cross-sectional area that ranges from between about 4 square inches to about 24 square inches. At a front portion 112″, bottom cushion 102 has a cross-sectional area that ranges from between about 6 square inches to about 30 square inches.

Those skilled in the art will recognize that although cross-sectional areas and thickness values for the cushions and compartments that make up the inventive case are described for an inflatable design, such values equally apply to non-inflatable designs where the cushion and the compartments are made from foam like material.

In accordance with one embodiment of the present invention, a process of manufacturing a surfboard case, such as the one shown in FIG. 2, includes fabricating a plurality of inflatable compartments (e.g., shown in FIGS. 6A and 6B). More preferably, these compartments are formed by either extrusion or casting such that when the compartments are inflated, their cross-sectional dimensions vary across the length of the compartments. Inflatable compartments will have apertures defined therein allowing them to be communicatively coupled to each other, allowing air to flow in and out of the various chamber during inflation and deflation of the cushions. In alternative embodiments of the present invention, where compartments are made from foam like material, similarly casting or extrusion is used during fabrication.

Regardless of whether an inflatable or non-inflatable design is being implemented, certain of the compartments will adhere to form a top cushion as shown in FIG. 4A and other compartments will adhere to form a bottom cushion as shown in FIG. 4B. The adhering process can include any technique well known in the art, but heat welding is a more preferred technique. Those skilled in the art will recognize that each of top cushion and bottom cushion will be fitted with a valve which allows air to be introduced inside and inflate them.

Next, a side rail cushion 118 as shown in FIG. 5 is fabricated according to well known techniques. The side rail cushion is preferably inflatable and attaches at between top cushion 102 and bottom cushion (not shown to simplify illustration in FIG. 5) to form an envelope with an opening which allows a surfboard to enter case 100 (as shown in FIG. 2).

Although certain examples have been described in terms. For example, the inventive case has been explained in terms of a surfboard, but can be used to transport any kind of board used for water sports, skiing etc.

What is claimed is:

1. A case capable of transporting a surfboard, comprising:
a top cushion designed to conform to a top surface of a surfboard;
a bottom cushion designed to conform to a bottom surface of the surfboard;
wherein each of said top and said bottom cushions include a plurality of compartments which have varying cross-sectional dimensions along a length of said compartments.

2. The surfboard case of claim 1, wherein said top and bottom cushions and said plurality of compartments are inflatable and said compartments have defined therein an aperture which allows air to travel from one compartment to another compartment.

3. The surfboard case of claim 1, further comprising a side rail cushion that is disposed between said top cushion and said bottom cushion and is designed to be adjacent to a side rail of said surfboard when said surfboard is encased inside said case.

4. The surfboard case of claim 2, wherein at a distance which equals between about 0 and about ⅓ of a length of said case and said distance measured from the front end of said case, a cross-sectional area of said compartment in an inflated state of said top cushion is between about 4 square inches and about 30 square inches.

5. The surfboard case of claim 2, wherein at a distance which equals between more than ⅓ and about ⅔ of a length of said case and said distance measured from a front end of said case, a thickness of said compartment of said top cushion in an inflated state is between about 6 square inches and about 30 square inches.

6. The surfboard case of claim 2, wherein at a distance which equals between about 0 and about ⅓ of a length of said case and said distance measured from a back end of said case, a thickness of said compartment of said top cushion in an inflated state is between about 4 inches and about 24 inches.

7. The surfboard case of claim 2, wherein at a distance which equals between about 0 and about ⅓ of a length of said case and said distance measured from a front end of said case, a thickness of said compartment of said bottom cushion in an inflated state is between about 6 square inches and about 30 square inches.

8. The surfboard case of claim 2, wherein at a distance which equals between about ⅓ and about ⅔ of a length of said case and said distance measured from a front end of said case, a thickness of said compartment of said bottom cushion in an inflated state is between about 4 square inches and about 24 square inches.

9. The surfboard case of claim 2, wherein at a distance which equals between about 0 and about ⅓ of a length of said case and said distance measured from a back end of said case, a thickness of said compartment of said bottom cushion in an inflated state is between about 4 square inches and about 30 square inches.

10. A case capable of transporting a surfboard, comprising:
a top inflatable cushion designed to conform to a top surface of a surfboard in an inflated state of said top cushion;
a bottom inflatable cushion designed to conform to a bottom surface of the surfboard in an inflated state of said bottom cushion;
wherein in an inflated state, each of said top and said bottom cushions vary in thickness along their length to protect said top surface and bottom of surfboard from being impacted from an external force when said surfboard is secured inside said case.

11. The case of claim 10, further comprising a side rail cushion that is capable of being disposed between said top and said bottom cushions.

12. The case of claim 11, wherein said top and said bottom cushion are inflatable such that in an inflated state said top cushion conforms to said to top surface of said surfboard and said bottom cushion conforms to said bottom surface of said surfboard and said case further comprising a first valve designed to inflate said top cushion, a second valve designed to inflate said bottom cushion and a third valve designed to inflate said side rail cushion.

13. The surfboard case of claim 12, wherein at a distance which equals between about 0 and about ⅓ of a length of said case and said distance measured from the front end of said case, a thickness of said compartment of said top cushion in an inflated state is between about 2 inches and about 4 inches.

14. The surfboard case of claim 12, wherein at a distance which equals between more than ⅓ and about ⅔ of a length of said case and said distance measured from a front end of said case, a thickness of said inflatable compartment of said top cushion in an inflated state is between about 2.5 inches and about 4.75 inches.

15. The surfboard case of claim 12, wherein at a distance which equals between about 0 and about ⅓ of a length of said case and said distance measured from a back end of said case, a thickness of said inflatable compartment of said top cushion in an inflated state is between about 2 inches and about 4.75 inches.

16. The surfboard case of claim 12, wherein at a distance which equals between about 0 and about ⅓ of a length of said case and said distance measured from a front end of said case, a thickness of said inflatable compartment of said bottom cushion in an inflated state is between about 2 inches and about 4.75 inches.

17. The surfboard case of claim 12, wherein at a distance which equals between about ⅓ and about ⅔ of a length of said case and said distance measured from a front end of said case, a thickness of said inflatable compartment of said bottom cushion in an inflated state is between about 2.5 inches and about 3.5 inches.

18. The surfboard case of claim 12, wherein at a distance which equals between about 0 and about ⅓ of a length of said case and said distance measured from a back end of said case, a thickness of said inflatable compartment of said bottom cushion in an inflated state is between about 2 inches and about 4.75 inches.

19. A method for manufacturing a case, comprising:
fabricating a plurality of longitudinal inflatable compartments having varying cross-sectional areas along their lengths; and
adhering some of said longitudinal compartments to form a top cushion and adhering others of said longitudinal compartments to form a bottom cushion.

20. The method of claim 19, further comprising:
fabricating a side rail cushion;
joining a portion of said side rail cushion to said top cushion and another portion of said side rail cushion to said bottom cushion for forming an envelope which is capable of receiving a surfboard.

21. The method of claim 19, wherein said fabricating includes extruding or casting.

22. The method of claim 19, wherein said adhering includes heat welding.

23. The method of claim 19, wherein said fabricating said plurality of longitudinal compartments includes forming inflatable compartment which include an aperture in each of said plurality of longitudinal compartments.

24. The method of claim 23, further comprising fabricating a first valve for providing air inside said top cushion, a second valve for providing air inside said bottom cushion and a third valve for providing air inside said side rail cushion.
